(19) United States
(12) Patent Application Publication
(10) Pub. No.: US 2008/0042594 A1
(43) Pub. Date: Feb. 21, 2008

(54) Power Supply for a Metal Vapour Lamp

(76) Inventors: Daniel Lopez, VS-Villingen-Obereschach (DE); Stefan Vogel, Brigachtal (DE); Martin Laeufer, VS-Obereschach (DE)

Correspondence Address: THOMSON LICENSING LLC, Two Independence Way, Suite 200, PRINCETON, NJ, 08540, US

(21) Appl. No.: 11/629,937

(22) PCT Filed: May 23, 2005
(86) PCT No.: PCT/EP05/52341

§ 371 Date: Dec. 18, 2006

(30) Foreign Application Priority Data
Jun. 30, 2004 (DE) 10 2004 031 944.8

(51) Int. Cl. H05B 41/24

(52) U.S. Cl. 315/283

(57) ABSTRACT

Power supply having a current generator and a starting generator for operating a lamp, the starting generator containing an inductance, which is arranged in the current path between the current generator and the lamp, and a high-voltage switch which is coupled to the inductance for the purpose of generating a voltage pulse for the lamp.

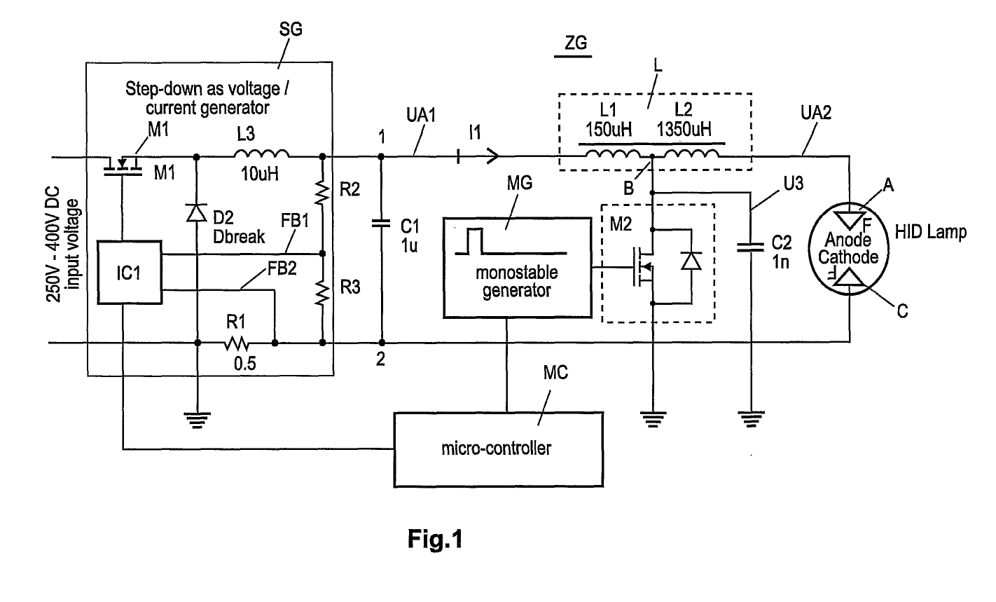

The present invention relates to a power supply for a lamp, in particular an HID mercury lamp (HID: high-intensity discharge lamp). A lamp of this type requires a high starting voltage in order to produce an arc between two electrodes in the lamp. Owing to the arc, part of the metal is vaporized, with the result that a plasma is produced which produces a current between the two electrodes and a light having a very high intensity. Mercury lamps of this type are used, for example, in rear-projection television sets which have a DLP (digital light processing) module for picture display purposes.

A power supply for such a lamp therefore needs to provide, after connection, initially a high starting voltage and, after starting of the lamp, a constant current having a defined value for optimal operation of the lamp. The current can be produced, for example, by a switched-mode power supply which has a current regulator. In order to produce the starting voltage, this switched-mode power supply needs to be supplemented, however, by a starting generator which is, for example, connected in series or in parallel with the lamp. If the starting circuit is arranged in parallel with the lamp, said starting circuit needs to be decoupled via diodes once the lamp has been started. However, these diodes have a high power loss during operation.

The object of the present invention is to specify a power supply for a metal vapour lamp which has low losses.

This object is achieved by a power supply according to claim 1. Advantageous exemplary embodiments of the invention are specified in the subclaims.

The power supply of the present invention contains a starting voltage generator which has an inductance, which is arranged in series between the current generator and the lamp, and a high-voltage switch which is arranged in parallel with the lamp and is coupled to the inductance. The high-voltage switch is turned on via a monostable generator if the lamp is intended to be started. If the high-voltage switch is turned on for the purpose of starting the lamp, energy is stored in the inductance and is passed on as a high voltage to the lamp for starting purposes once the high-voltage switch has been turned off.

In one preferred exemplary embodiment, the inductance is a coil having a central tap which divides the coil into two parts. The high-voltage switch is in this case coupled to a current input at the tap and is connected to a current output having a reference potential, for example ground. The coil has a core having an air gap which is so small that the coil has a high inductance when there is a low current flow and passes over to saturation when there is a high current flow and, as a result, has a very low inductance during operation of the lamp. A relatively thick wire is wound around the coil such that an operating current of 4 amperes produces a power loss of less than 2 watts in the coil.

One preferred exemplary embodiment of the invention will be explained in more detail below by a way of example with reference to a schematic drawing, in which:

the FIGURE shows a power supply for the operation of a metal vapour lamp.

The FIGURE shows a power supply having a current generator SG for operating an HID lamp, for example a metal vapour lamp, in particular a mercury lamp. The lamp has an anode A and a cathode C which are connected to connections 1 and 2 of the current generator SG.

The current generator SG has a transistor switch M1 which is controlled by an integrated circuit IC1 for the purpose of producing an output current I1. It also has a coil L3 and a diode D2 which are arranged in accordance with the functional principle of a step-down transformer. Switched-mode power supplies of this type, which operate as step-down transformers, are sufficiently well known.

The current generator SG also has a closed-loop control circuit having resistors R1, R2, R3 for the purpose of stabilizing the current I1. The resistors R2 and R3 are in this case arranged as voltage dividers between the two connections 1 and 2 for a first feedback loop FB1 for the integrated circuit IC1. The resistor R1 is arranged in the current path of the lamp Q for a second feedback loop FB2 for the integrated circuit IC1, which is provided for current regulation purposes. Circuits of this type are known.

In order to produce a starting voltage for the lamp Q, the power supply according to the invention has a starting voltage generator ZG which contains an inductance L, a high-voltage switch M2 and a driver circuit for the purpose of controlling the high-voltage switch M2, in this exemplary embodiment a monostable generator MG.

In this exemplary embodiment, the inductance L is a coil having a tap B which divides the coil into two parts L1 and L2. The two coil parts L1, L2 are connected in series between the current generator SG, in this case connection 1, and the anode A of the lamp Q. The high-voltage switch M2 is connected to a current input at the tap B, and the current output of the high-voltage switch M2 is connected to ground. The high-voltage switch is, for example, a MOSFET and is used as a switching transistor. In addition, a capacitor C2 is connected in parallel with the high-voltage switch M2 for the purpose of damping voltage peaks or for the purpose of producing an oscillation.

The coil contains a core which has a very small air gap such that the inductance passes rapidly over to saturation in the case of a higher current, in particular during operation of the lamp Q. The turns ratio of the two coil parts L1/L2 is, for example, 1:4, with inductances of L1:150 μH and L2:1350 μH.

The monostable generator MG and the current generator SG are controlled by means of a microcontroller MC. If the power supply is intended to be switched on, the microcontroller MC initially drives the current generator SG so as to switch it on such that it produces an output voltage UA1 at the outputs 1 and 2. In order to start the lamp, the monostable generator MG is then driven by the microcontroller MC. Said microcontroller MC turns the high-voltage switch M2 on for a defined period of time such that a saw-tooth current flows, starting from the current generator SG, via the coil part L1 and the high-voltage switch M2, to ground. As a result, energy is stored in the core of the inductance L.

If the high-voltage switch M2 is then turned off, the energy in the inductance L is discharged, in particular a voltage UA2 across the connections of the lamp Q being produced via the coil part L2 owing to the high turns number, and this voltage UA2 is sufficient for starting the lamp. As a result, in particular an oscillation is produced between the coil part L2 and the capacitor C2, and this oscillation is semi-sinusoidal, since it is rectified by the lamp Q, and is present between the anode and the cathode of the lamp Q. These voltage pulses produce a first current in the lamp Q so as to start the lamp. The starting voltage generator ZG is, for example, operated at a voltage U1 which is 20 volts and which is stepped up at the high-voltage switch M2 by the inductance L to a voltage U3 of approximately 600 volts when the switch is turned off. This results in a starting voltage UA2 of approximately 2400 volts across the lamp.

When the lamp has been started, the impedance of the lamp Q drops rapidly, and a continuous current flows through the lamp which is produced by the current generator SG. The current I1 is in this case above 1 ampere and flows through the two coil parts L1, L2 such that the core of the coil L is saturated and the inductance of the coil drops from, for example, a few millihenrys to a few microhenrys.

In this case, a relatively thick wire for the winding is used for the coil L such that the power loss of the coil L at a current of 4 amperes is less than 2 watts. The power loss of the starting generator ZG is as a result considerably less than that of a starting voltage generator which is connected in parallel and contains diodes for decoupling purposes. Said diodes have, for example, a power loss of 6 watts at a current of 4 amperes. The starting generator according to the invention also has the advantage that the amplitude and the pulse shape of the starting pulses can be set very precisely by the circuit.

1. Power supply having a current generator and a starting generator for operating a lamp, wherein the starting generator contains an inductance, which is arranged in the current path between the current generator and the lamp, and a high-voltage switch which is coupled to the inductance (L) for the purpose of generating a voltage pulse for the lamp.

2. Power supply according to claim 1, wherein the inductance is a coil having two coil parts which have a tap to which the high-voltage switch is coupled.

3. Power supply according to claim 1, wherein the inductance has a core having an air gap which is so small that the inductance is at saturation during normal operation of the lamp.

4. Power supply according to claim 1, wherein the high-voltage switch is driven by a monostable generator.

5. Power supply according to claim 1, wherein a capacitance is arranged in parallel with the high-voltage switch.

6. Power supply according to claim 1, wherein the power supply is connected to a metal vapour lamp, in particular to a mercury lamp.
